(19) United States
(12) Patent Application Publication
(10) Pub. No.: US 2026/0195663 A1
(43) Pub. Date: Jul. 9, 2026

(54) INFORMATION PROCESSING APPARATUS, INFORMATION PROCESSING METHOD, AND COMPUTER-READABLE STORAGE MEDIUM

(71) Applicant: HONDA MOTOR CO.,LTD., Tokyo (JP)

(72) Inventors: Tatsuya IDE, Tokyo (JP); Yoshiya NAKAGAWA, Tokyo (JP)

(21) Appl. No.: 19/422,307

(22) Filed: Dec. 16, 2025

(30) Foreign Application Priority Data
Jan. 7, 2025 (JP) 2025-002493

(51) Int. Cl. G06Q 10/02; G06Q 10/0631; G06Q 50/06; G06Q 50/40

(52) U.S. Cl. CPC G06Q 10/02; G06Q 10/06311; G06Q 50/06; G06Q 50/40

(57) ABSTRACT

An information processing apparatus includes: a location-information acquisition unit which acquires location information; a required duration acquisition unit which acquires required duration information indicating a duration required for the movable body to travel, calculated based on the location information; an accepting unit which accepts information that has been input into a plurality of input items on a time at which, or a duration for which the movable body travels; a determination unit which determines that information has been input into a predefined number of at least one input item among the plurality of input items; and a calculation unit which, when the determination unit determines that the information has been input into the predefined number of at least one input item, calculates information on at least one input item among the plurality of input items, into which no information has been input.

The contents of the following patent application(s) are incorporated herein by reference: NO. 2025-002493 filed in JP on January 7, 2025.

### BACKGROUND

### Technical Field

The present invention relates to an information processing apparatus, an information processing method, and a computer-readable storage medium.

### Related Art

Patent document 1 discloses that a required passage duration considering congestion information to a goal or the like can be calculated, and a realistic estimated arrival time to the goal can be obtained when planning a drive.

### Related Art Documents

### Patent Documents

Patent Document 1: Japanese Patent Application Publication No. 2003-279369

### BRIEF DESCRIPTION OF THE DRAWINGS

FIG. 1 conceptually illustrates a utilization form of a system 5 in an embodiment.

FIG. 2 illustrates an example of a system configuration of a vehicle management apparatus 60.

FIG. 3 illustrates an example of a system configuration of an integrated management apparatus 50.

FIG. 4 illustrates an execution sequence of processing in a method performed by a power control apparatus 40, the integrated management apparatus 50, and the vehicle management apparatus 60.

FIG. 5 illustrates a screen 500 that provides a user interface provided to a user 20.

FIG. 6 illustrates a screen 600 that provides the user interface provided to the user 20.

FIG. 7 illustrates a screen 700 that provides the user interface provided to the user 20.

FIG. 8 illustrates a screen 800 that provides the user interface provided to the user 20.

FIG. 9 illustrates a screen 900 that provides the user interface provided to the user 20.

FIG. 10 illustrates arbitration of an operation plan of a vehicle 10 and an electricity plan in an office 30.

FIG. 11 illustrates the operation plan of the vehicle 10 after being arbitrated by the integrated management apparatus 50.

FIG. 12 is a flowchart of information processing for a travel schedule of the vehicle 10 executed by the system 5.

FIG. 13 illustrates an example of a computer 2000 in which a plurality of embodiments of the present invention may be entirely or partially embodied.

### DESCRIPTION OF EXEMPLARY EMBODIMENTS

Hereinafter, the present invention will be described through embodiments of the invention, but the following embodiments do not limit the invention according to the claims. In addition, not all of the combinations of features described in the embodiments are essential to the solutions of the invention.

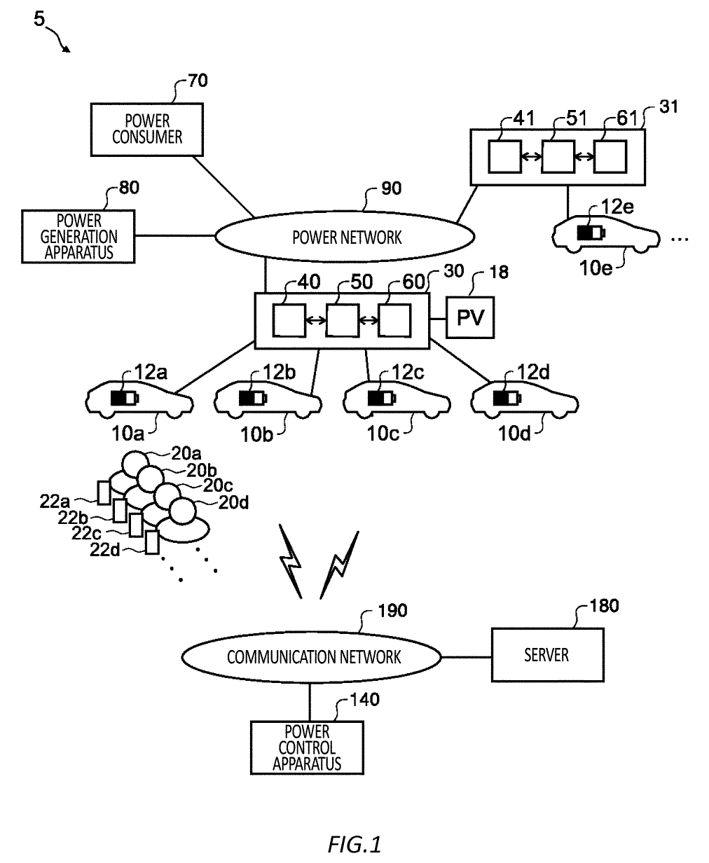

FIG. 1 conceptually illustrates a utilization form of a system 5 in an embodiment. The system 5 includes: a power generation apparatus 80; a plurality of vehicles including a vehicle 10a, a vehicle 10b, a vehicle 10c, a vehicle 10d and a vehicle 10e; a plurality of terminals including a terminal 22a, a terminal 22b, a terminal 22c and a terminal 22d; a power control apparatus 40 and a power control apparatus 41; an integrated management apparatus 50 and an integrated management apparatus 51; a vehicle management apparatus 60 and a vehicle management apparatus 61; a power control apparatus 140; and a server 180.

A power consumer 70 and the power generation apparatus 80 are connected to a power network 90. The electric power generated by the power generation apparatus 80 can be supplied to the power consumer 70 through the power network 90. The power network 90 is a power system, for example.

The vehicle 10a, the vehicle 10b, the vehicle 10c, the vehicle 10d, and the vehicle 10e are electric vehicles respectively including a battery 12a, a battery 12b, a battery 12c, a battery 12d, and a battery 12e in which driving electric power for the vehicle to drive is accumulated. The electric vehicle is an example of an electrically-driven vehicle. The electric vehicle is an example of a movable body. In the present embodiment, in particular, the vehicle 10a, the vehicle 10b, the vehicle 10c, and the vehicle 10d may be collectively referred to as a "vehicle 10", and the battery 12a, the battery 12b, the battery 12c, and the battery 12d may be collectively referred to as a "battery 12". The battery 12 is an example of an "energy accumulation apparatus".

The terminal 22a is a terminal that a user 20a uses; and the terminal 22b is a terminal that a user 20b uses; and the terminal 22c is a terminal that a user 20c uses; and the terminal 22d is a terminal that a user 20d uses. In the present embodiment, the terminal 22a, the terminal 22b, the terminal 22c, and the terminal 22d may be collectively referred to as a "terminal 22". The user 20a, the user 20b, the user 20c, and the user 20d may be collectively referred to as a "user 20". The user 20 is a user of the vehicle 10. The user 20 makes a usage reservation of the vehicle 10 by using the terminal 22. The vehicle 10 is an example of a "reservation target".

The vehicle 10 is deployed in an office 30. The office 30 functions as a home point for parking the vehicle 10. In the present embodiment, the office 30 may be referred to as "headquarters". The vehicle 10 may be, for example, a vehicle for commercial use or may be a vehicle for carrying shipments such as products handled by the office 30. Power is supplied to the office 30 through the power network 90.

The power control apparatus 40, the integrated management apparatus 50, and the vehicle management apparatus 60 are provided in the office 30. The vehicle 10 is provided to be able to communicate with the vehicle management apparatus 60 through a mobile communication network or the like. The office 30 has a local power network in the office, and electric power exchange with the battery 12 included in the vehicle 10 can be performed through a charge-and-discharge apparatus provided in the office 30 and the power network in the office 30. That is, the vehicle 10 can be used for energy management in the office 30. For example, the vehicle 10 can be used to perform peak shaving of the power consumption in the office 30. The battery 12 included in the vehicle 10 can perform the electric power exchange with the power network 90 through a power network in the office 30. The power control apparatus 40 controls charging and discharging of the vehicle 10 deployed in the office 30 so as to at least satisfy a power demand in the office 30.

A power generation apparatus 18 is provided in the office 30. The power generation apparatus 18 generates electric power from renewable energy. Specifically, the power generation apparatus 18 generates electric power from natural energy. Examples of natural energy may include energy obtained from natural phenomena, such as solar, geothermal, wind, and tidal flow. The power generation apparatus 18 generates electric power from at least one of solar light, wind, solar heat, ambient heat, or other heat existing in nature, and tidal flow. The electric power generated by the power generation apparatus 18 is, through the power network in the office 30, supplied to and consumed by an electrical load in the office 30, which is a power consumer. The electric power generated by the power generation apparatus 18 can be used to charge the battery 12 included in the vehicle 10 through the power network in the office 30 and the charge-and-discharge apparatus provided in the office 30. The electric power generated by the power generation apparatus 18 can be used for performing electric power exchange with the power network 90 through the power network in the office 30.

The power control apparatus 40, the integrated management apparatus 50, and the vehicle management apparatus 60 are managed, for example, in the office 30. The power control apparatus 40 and the integrated management apparatus 50 are provided to be able to communicate with each other through a communication line. The integrated management apparatus 50 and the vehicle management apparatus 60 are provided to be able to communicate with each other through a communication line. The integrated management apparatus 50 and the vehicle management apparatus 60 may be provided outside the office 30. The integrated management apparatus 50 and the vehicle management apparatus 60 may be provided to be able to communicate with each other through a communication line such as the Internet. One or both of the integrated management apparatus 50 and the vehicle management apparatus 60 may be embodied as a server, such as a cloud server.

The user 20 makes a usage reservation of the vehicle 10 by using the terminal 22. For example, the user 20 inputs a time of departure from the office 30, a travel destination, and a time of return to the office 30 into the terminal 22. The terminal 22 transmits reservation information to the vehicle management apparatus 60 through a communication network 190.

The vehicle management apparatus 60 decides a time of departure of the vehicle 10 from the office 30, a stay duration at the travel destination, and a time of return, based on the reservation information received from the terminal 22. The integrated management apparatus 50 may perform arbitration to adjust the time of departure and the time of return of the vehicle 10 from/to the office 30 so as to satisfy the power demand at the office 30. For example, the integrated management apparatus 50 may perform arbitration to adjust the time of departure and the time of return of the vehicle 10 from/to the office 30 so that peak shaving of the power demand in the office 30 can be performed. The vehicle management apparatus 60 manages the vehicle 10 based on a schedule of the vehicle 10 adjusted by the integrated management apparatus 50. The power control apparatus 40 controls charging and discharging of the battery 12 included in the vehicle 10 based on the schedule of the vehicle 10 adjusted by the integrated management apparatus 50.

The vehicle 10e is deployed in an office 31. The office 31 functions as a home point for parking the vehicle 10e. Similar to the vehicle 10, the vehicle 10e may be a vehicle for commercial use or may be a vehicle for carrying shipments such as products handled by the office 31. Power is supplied to the office 31 through the power network 90. The power control apparatus 41, the integrated management apparatus 51, and the vehicle management apparatus 61 are provided in the office 31.

In the office 31, the power control apparatus 41, the integrated management apparatus 51, and the vehicle management apparatus 61 correspond to the power control apparatus 40, the integrated management apparatus 50, and the vehicle management apparatus 60. The power control apparatus 41, the integrated management apparatus 51, and the vehicle management apparatus 61 perform control similar to that of the power control apparatus 40, the integrated management apparatus 50, and the vehicle management apparatus 60 except that a control target and/or a management target is the office 31 and/or the vehicle 10e. For this reason, the description of the control related to the power control apparatus 41, the integrated management apparatus 51, the vehicle management apparatus 61, and the vehicle 10e is omitted.

The power control apparatus 140 communicates with the power control apparatus 40 and the power control apparatus 41 through a communication network 190, and supervises overall power control in the office 30 and the office 31. For example, the power control apparatus 140 collects information related to power supply and demand from the power control apparatus 40 and the power control apparatus 41, and performs adjustment of overall power supply and demand including electricity transaction with the power network 90, so that the power control apparatus 40 and the power control apparatus 41 are caused to perform control so as to minimize the total electricity cost of the office 30 and the office 31.

The power control apparatus 140 is connected to the server 180 through the communication network 190. The server 180 is, for example, a server used by a power aggregator. The server 180 conducts electricity transactions in an electricity market. The power control apparatus 140 can provide the server 180 with power resources that are held by aggregating the vehicles deployed in the office 30 and the office 31. The power control apparatuses 40 and 41 control charging and discharging of the battery of each of the vehicles deployed in the office 30 and the office 31, and the power control apparatus 140 provides electric power agreed by the server 180. For example, according to the demand from the server 180, the power control apparatus 140 controls charging and discharging of the battery 12 controlled by the power control apparatus 40 and the power control apparatus 41 to provide electric power corresponding to the demand.

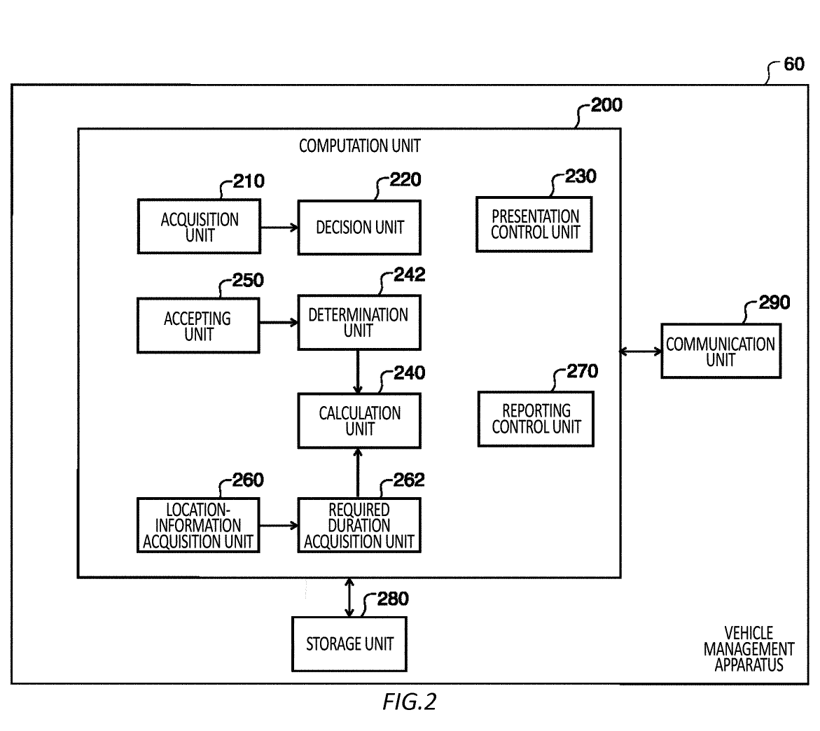

The control mainly related to the office 30 will be described with reference to FIG. 2 to FIG. 12, etc. Specifically, control related to the power control apparatus 40, the integrated management apparatus 50, the vehicle management apparatus 60, and the vehicle 10 is described. However, the control related to the office 30 can be applied to the control related to the office 31.

FIG. 2 illustrates an example of a system configuration of the vehicle management apparatus 60. The vehicle management apparatus 60 includes a computation unit 200, a storage unit 280, and a communication unit 290. The vehicle management apparatus 60 performs information processing for a travel schedule of the vehicle 10. The vehicle management apparatus 60 functions as at least a part of an information processing apparatus that performs information processing for the travel schedule of the vehicle 10.

The computation unit 200 performs control of the communication unit 290. The communication unit 290 is responsible for communication between the vehicle 10, the integrated management apparatus 50, and the terminal 22, for example. The computation unit 200 is embodied as an arithmetic processing unit including a processor. Each storage unit 280 is embodied to include a non-volatile storage medium. The computation unit 200 performs processing by using the information stored in the storage unit 280. The computation unit 200 may be embodied as a microcomputer including a CPU, a ROM, a RAM, an I/O, a bus, and the like. The vehicle management apparatus 60 may be embodied as a computer.

In the present embodiment, the vehicle management apparatus 60 shall be embodied as a single computer. However, in another embodiment, the vehicle management apparatus 60 may be embodied as a plurality of computers. At least some of functions of the vehicle management apparatus 60 may be implemented by one or more servers, such as a cloud server.

The computation unit 200 includes an acquisition unit 210, a decision unit 220, a presentation control unit 230, a calculation unit 240, a determination unit 242, an accepting unit 250, a location-information acquisition unit 260, a required duration acquisition unit 262, and a reporting control unit 270.

The location-information acquisition unit 260 acquires location information that includes information indicating a scheduled departure location of the vehicle 10, travel destination information indicating a first location scheduled as a travel destination of the vehicle 10, and information indicating a scheduled return location of the vehicle 10. The required duration acquisition unit 262 acquires required duration information indicating a duration required for the vehicle 10 to travel, calculated based on the location information acquired by the location-information acquisition unit 260.

The accepting unit 250 performs processing for accepting information that has been input into a plurality of input items on a time at which, or a duration for which the vehicle 10 travels. The plurality of input items may include an input item of a scheduled stay duration at the first location. The plurality of input items may include input items of a scheduled departure time at which the vehicle 10 departs from the scheduled departure location, the scheduled stay duration, and a scheduled return time at which the vehicle 10 returns to the scheduled return location.

The determination unit 242 performs processing for determining that information has been input into a predefined number of at least one input item among the plurality of input items. The calculation unit 240, when it is determined that the information has been input into the predefined number of at least one input item, performs processing for calculating information on at least one input item among the plurality of input items, into which no information has been input, based on the information that has been input into the predefined number of at least one input item having the information input thereinto, the location information, and the required duration information. The predefined number may be less than a number of the plurality of input items and may be two or more. This allows the amount of information exchange required for an operation management of the vehicle 10 to be reduced. For the user 20, the cumbersomeness when the user 20 inputs information can be reduced.

The required duration information may include information indicating a first required duration, which is required for the vehicle 10 to travel from the scheduled departure location to the first location, and a second required duration, which is required for the vehicle 10 to travel from the first location to the scheduled return location. The travel destination information may further include information indicating a second location scheduled as a travel destination of the vehicle 10, and the required duration information may further include information indicating a third required duration, which is required to travel between the first location and the second location.

The plurality of input items may include input items of a first scheduled stay duration at the first location and a second scheduled stay duration at the second location. The plurality of input items may include input items of a scheduled departure time at which the vehicle 10 departs from the scheduled departure location, the first scheduled stay duration, the second scheduled stay duration, and a scheduled return time at which the vehicle 10 returns to the scheduled return location.

The presentation control unit 230 performs control for causing a plurality of input fields for the user to perform input of information on the plurality of input items to be presented for each of the plurality of input items. The presentation control unit 230 performs control for causing an input field that corresponds to an input item for which the calculation unit 240 is to calculate the information, among the plurality of input fields, to present that the calculation unit 240 is to calculate the information.

The presentation control unit 230 performs control for causing the plurality of input fields to be presented simultaneously. This realizes high viewability, which facilitates grasping information and adjusting input content.

The reporting control unit 270 performs control for performing reporting when the information calculated by the calculation unit 240 satisfies a predefined condition. The predefined condition may be set for each of the plurality of input items.

The decision unit 220 predicts, based on the reservation information indicating the usage reservation of the vehicle 10, a transition of an amount of accumulated energy in the energy accumulation apparatus equipped in the vehicle 10. The decision unit 220 further performs, based on the information that has been input into the plurality of input items and the information calculated by the calculation unit 240, processing for energy exchange between the vehicle 10 and the outside of the vehicle 10 at the first location.

The acquisition unit 210 acquires the reservation information on a reservation of the vehicle 10. For example, the acquisition unit 210 acquires the reservation information transmitted from the terminal 22. The reservation information may include the location information that includes the information indicating the scheduled departure location of the vehicle 10, the travel destination information indicating the first location and/or the second location scheduled as travel destinations of the vehicle 10, and information indicating the scheduled return location of the vehicle 10, the scheduled departure time at which the vehicle 10 departs from the scheduled departure location, the scheduled stay duration at the first location and/or the second location, and the scheduled return time at which the vehicle 10 returns to the scheduled return location. The storage unit 280 stores the reservation information. The decision unit 220 acquires the reservation information from the storage unit 280 and devises, based on the reservation information thus acquired, an operation plan of the vehicle 10.

The communication unit 290 transmits the operation plan to the integrated management apparatus 50. The communication unit 290 may further transmit at least a part of the reservation information to the integrated management apparatus 50. When the vehicle 10 to be used by the user is changed due to arbitration of competing reservations, the communication unit 290 may transmit a notification indicating that the vehicle 10 is changed, to the user 20 for whom the vehicle 10 thus changed was reserved. The communication unit 290 may transmit and receive information to/from the terminal 22 according to control by the presentation control unit 230 and the reporting control unit 270.

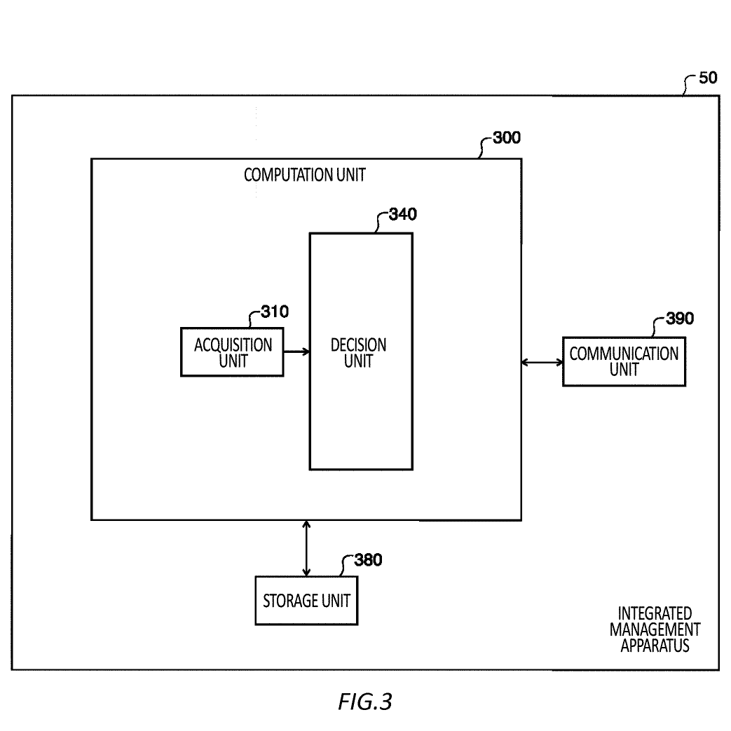

FIG. 3 illustrates an example of a system configuration of the integrated management apparatus 50. The integrated management apparatus 50 includes a computation unit 300, a storage unit 380, and a communication unit 390. The integrated management apparatus 50 performs information processing for a usage plan of the vehicle 10. The integrated management apparatus 50 functions as at least a part of an information processing apparatus that performs information processing for the usage plan of the vehicle 10.

The computation unit 300 performs control of the communication unit 390. The communication unit 390 is responsible for communication in the integrated management apparatus 50. The communication unit 390 is responsible for communication between at least the power control apparatus 140, the vehicle management apparatus 60, and the power control apparatus 40 and the integrated management apparatus 50. The computation unit 300 is embodied as an arithmetic processing unit including a processor. Each storage unit 380 is embodied to include a non-volatile storage medium. The computation unit 300 performs processing by using the information stored in the storage unit 380. The computation unit 300 may be embodied as a microcomputer including a CPU, a ROM, a RAM, an I/O, a bus, and the like. The integrated management apparatus 50 may be embodied as a computer.

In the present embodiment, the integrated management apparatus 50 shall be embodied to include a single computer. However, in another embodiment, the integrated management apparatus 50 may be implemented by a plurality of computers. At least some of functions of the integrated management apparatus 50 may be embodied to include one or more servers, such as a cloud server. In the present embodiment, the integrated management apparatus 50 and the vehicle management apparatus 60 may be embodied as a same computer or may be embodied as computers different from each other. All or at least some of the functions of the integrated management apparatus 50 and the vehicle management apparatus 60 may be implemented by the same computer.

The computation unit 300 includes an acquisition unit 310 and a decision unit 340.

The acquisition unit 310 acquires information on the reservation information to reserve a usage of the vehicle 10. Specifically, the acquisition unit 310 acquires information indicating the operation plan generated by the vehicle management apparatus 60. The acquisition unit 310 acquires energy request information on a request for energy that is to be provided from the vehicle 10. For example, the acquisition unit 310 accepts the energy request information from the power control apparatus 40. The energy request information may include information indicating a requested amount of energy and information indicating a time period for which energy is requested. Information indicating an electricity plan decided by the power control apparatus 40 is an example of the energy request information.

The decision unit 340 decides, based on the information indicating the operation plan and the energy request information, which are acquired by the acquisition unit 310, the usage plan of the vehicle 10. For example, the decision unit 340 decides, based on the information indicating the operation plan and the information indicating the electricity plan, a time period for which the vehicle 10 is to be used to drive and a time period for which the vehicle 10 is to be used to provide electric power to the office 30. For example, the decision unit 340 may decide the time period for which the vehicle 10 is to be used to drive and the time period for which the vehicle 10 is to be used to provide electric power by regarding a time period for which the vehicle 10 is not to be used to drive as a time period for which the vehicle 10 is able to be used to provide electric power for the office 30. When the time period for which the vehicle 10 is to be used to drive and the time period for which the vehicle 10 is to be used to provide electric power cannot be decided, the decision unit 340 performs arbitration of the operation plan and the electricity plan. For example, the decision unit 340 decides an adjustment amount of the time period for which the vehicle 10 is to be used to drive and/or an adjustment amount of the time period for which the vehicle 10 is to be used to provide electric power, and transmits a result of the arbitration indicating the adjustment amounts thus decided to the vehicle management apparatus 60 and the power control apparatus 40. This allows the vehicle management apparatus 60, the power control apparatus 40, and the integrated management apparatus 50 to cooperate with each other, enabling to decide a usage schedule of the vehicle 10 based on an amount of energy at a predefined time point in the future predicted by the power control apparatus 40.

In the present embodiment, the description will focus on "electric power" as an example of "energy". In the present embodiment, electric power exchange is an example of "energy exchange". However, energy is not limited only to electric power. As an example, an embodiment that uses fuel such as hydrogen as an energy source, as a form of "energy", can be employed.

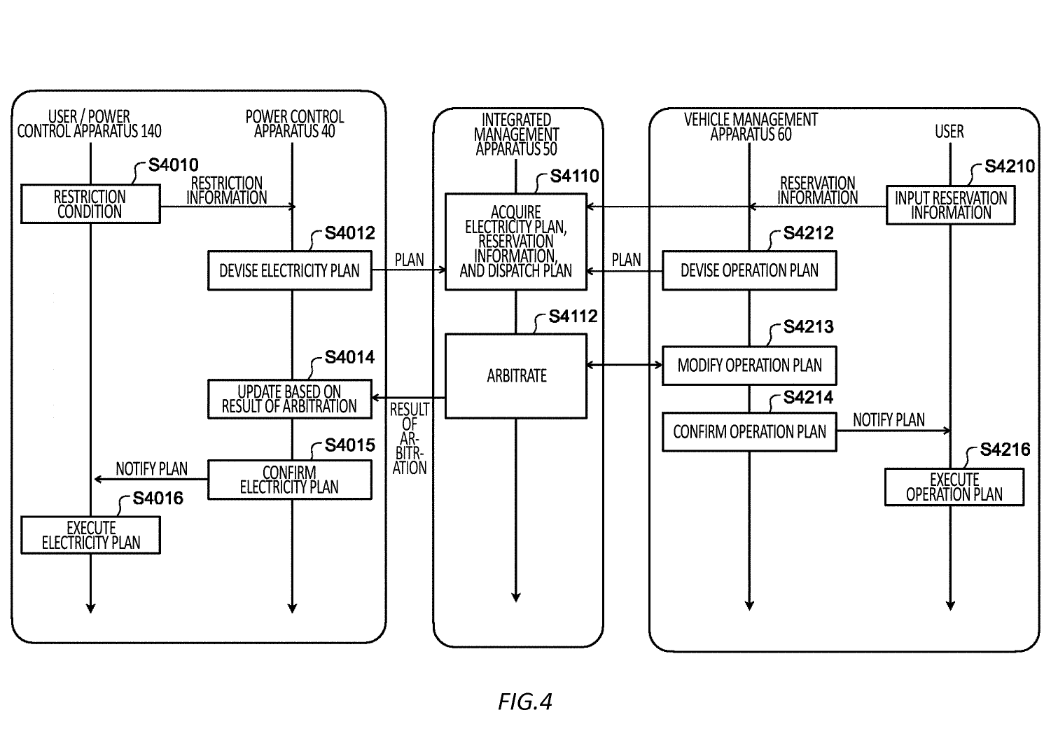

FIG. 4 illustrates an execution sequence of processing in a method performed by the power control apparatus 40, the integrated management apparatus 50, and the vehicle management apparatus 60. The processing of FIG. 4 represents processing from devising of an electricity plan and an operation plan on a particular date until various types of control are performed according to the plans thus devised. The devising of the electricity plan and the operation plan is performed on a day before the target particular date or at a relatively early time on the particular date.

As control for the power control apparatus 40, in S4010, at least one of a user of the power control apparatus 40 or the power control apparatus 140 sets a restriction condition on the electricity plan in the office 30 to notify the power control apparatus 40 thereof. The power control apparatus 140 may set the restriction condition in the office 30 so as to minimize the overall electricity cost in the office 31 and the office 30. The user is a person or a system that inputs information on power management into the power control apparatus 40 in the office 30. The restriction condition is a condition which becomes a restriction for devising of the electricity plan. The restriction condition may include a restriction that is required to meet the power demand. The restriction condition includes a predicted amount of generated electric power, a predicted power consumption, and information on an electricity charge, for example. The amount of generated electric power is an amount of generated electric power by the power generation apparatus 80, for example. The power consumption is a power consumption in the office 30. The electricity charge includes an electricity purchase price, an electricity selling price, and a monetary consideration obtained by reducing the power consumption according to a demand response. The electricity purchase price is, for example, a condition related to an amount of money charged as a monetary consideration for power reception by the office 30 from the power network 90. The electricity selling price is, for example, a condition related to an amount of money obtained as a monetary consideration for power supply by the office 30 to the power network 90.

In S4012, the power control apparatus 40 devises an electricity plan for a target date in the office 30 based on restriction information. The electricity plan includes a power consumption for each time frame in one day. The electricity plan defines how much electric power is consumed for each time frame in the office 30. The power consumption for each time frame on the target date may be predicted from environmental information, such as weather information on the target date, and data of past performance. The electricity plan may include peak-shaving information for performing peak shaving. The peak-shaving information may include information indicating how much power consumption is to be suppressed during what time frame in the office 30. The peak-shaving information may include information indicating how much power is to be received from the outside during what time frame in the office 30.

The power control apparatus 40 may devise an optimal electricity plan in the office 30. For example, the power control apparatus 40 may devise an electricity plan so as to minimize the amount of electric power received from the power network 90 in the office 30. The power control apparatus 40 may devise an electricity plan so as to minimize the amount of money charged as a monetary consideration for power reception from the power network 90 received in the office 30. On condition that the contracted power in at least the office 30 is complied with, the power control apparatus 40 may devise an electricity plan so as to maximize an amount of money obtained as a monetary consideration for reducing the power consumption in the office 30 according to the demand response in the office 30 or performing power supply to the power network 90. In this manner, the power control apparatus 40 devises the optimal electricity plan as the electricity plan on the target date in the office 30 based on the restriction condition. According to this electricity plan, an amount of electric power that needs to be received from the outside for each time frame on the target date is defined. The amount of electric power that needs to be received from the outside may be supplied from the battery 12 included in the vehicle 10 parked in the office 30. The power control apparatus 40 transmits the electricity plan thus devised to the integrated management apparatus 50.

As control for the vehicle management apparatus 60, in S4210, the user inputs reservation information on dispatching of the vehicle 10. The user is a person who uses the vehicle 10, a manager of the system, the system, or the like. The reservation information includes a condition that may become a restriction on devising of the operation plan. The reservation information includes a departure point, a destination, and a return point, and a departure time at the departure point, a return time and a departure time at the destination, and a return time to the return point, and so on, for example. The departure point and the destination define from which location to which location the vehicle 10 needs to drive. For the departure time at the departure point and the return time at the return point, a duration adjustment allowance may be set, which indicates a duration for which a change in the departure time and the return time is allowed to be made. The reservation information input in S4210 is transmitted to the vehicle management apparatus 60 and also transmitted to the integrated management apparatus 50 through the vehicle management apparatus 60.

In S4212, the decision unit 220 of the vehicle management apparatus 60 devises an operation plan on the target date in the office 30 by aggregating the restriction conditions which has been notified of by the user 20. For example, the decision unit 220 decides the vehicle 10 to be used for transporting a person, a drive route of the vehicle 10, and a drive speed of the vehicle 10, so as to satisfy a transportation demand defined by the reservation information. The vehicle management apparatus 60 transmits the operation plan thus devised to the integrated management apparatus 50.

In S4110, the integrated management apparatus 50 accepts the electricity plan transmitted from the power control apparatus 40 as well as the reservation information and the operation plan transmitted from the vehicle management apparatus 60.

In S4112, the decision unit 340 of the integrated management apparatus 50 determines whether or not the electricity plan in the office 30 is satisfied if the vehicle 10 is operated according to the operation plan. For example, the operation plan defines a time period for which it is predicted that the vehicle 10 will exit in the office 30. The decision unit 340 determines that the electricity plan is satisfied if it is predicted that, in a time period that the office 30 needs power supplied from the outside, electric power can be received from the battery 12 included in the vehicle 10 existing at the office 30 for the time period in question.

When it is determined that the electricity plan cannot be satisfied if the vehicle 10 is dispatched according to the operation plan, the decision unit 340 determines how the operation plan should be modified so that the electricity plan can be satisfied. For example, the decision unit 340 decides the adjustment amount of the departure time and the return time of the vehicle 10 in the operation plan as the result of the arbitration. The decision unit 340 may decide information that the vehicle 10 to be used by the user 20 defined by the operation plan should be changed as the result of the arbitration. The result of the arbitration may include information indicating a time period for which the vehicle 10 is to be used to perform peak shaving in the office 30.

The integrated management apparatus 50 transmits the result of the arbitration thus decided to the vehicle management apparatus 60. Upon receiving the result of arbitration from the integrated management apparatus 50, the decision unit 220 of the vehicle management apparatus 60 decides a usage plan of the vehicle 10 by modifying the operation plan devised in S4212 based on the result of the arbitration (S4213). For example, the decision unit 220 modifies the operation plan so that the reservation information is satisfied based on the adjustment amount of the departure time and the return time received from the integrated management apparatus 50. The vehicle management apparatus 60 transmits a result of modifying the operation plan to the integrated management apparatus 50. The integrated management apparatus 50 and the vehicle management apparatus 60 repeat the processes in S4112 and S4213 to decide a performable operation plan. In S4213, the decision unit 220 decides the performable operation plan by deciding an operation route of the vehicle 10 and judging whether or not the vehicle 10 can return to the office 30 without running out of charge when causing the vehicle 10 to drive so that the departure time and the return time designated by the reservation information can be complied with, based on SOC and power consumption rate of the vehicle 10. Also, in S4112, considering an amount of electricity cost reduced in the office 30 when electric power exchange between the battery 12 and the office 30 according to the electricity plan thus decided is performed, and necessary operational cost of the vehicle 10 and utilization rate of the vehicle 10 when the vehicle 10 is operated according to the operation plan, the decision unit 340 may judge that the operation plan is performable, on condition that it is determined to be profitable in total.

When the operation plan is decided, the result of the arbitration including the operation plan is transmitted to the power control apparatus 40. Upon receiving the result of the arbitration from the integrated management apparatus 50, the power control apparatus 40 updates the electricity plan based on the result of arbitration (S4014), and notifies the user of the electricity plan confirmed by updating based on the result of arbitration (S4015). In S4016, the user and the power control apparatus 140 execute control according to the electricity plan thus notified of.

The vehicle management apparatus 60 confirms the operation plan finally decided in S4213 (S4214). When receiving a presentation request for the operation plan through the terminal 22 from the user 20, the vehicle management apparatus 60 notifies the user of the operation plan thus confirmed through the communication unit 290. In S4216, the user performs control of operating the vehicle 10 according to the operation plan thus notified of. For aspects of presenting the operation plan, an aspect of presenting in a time frame where the operation plan has been confirmed and an aspect of presenting in a time frame where the operation plan has not been confirmed will be described below.

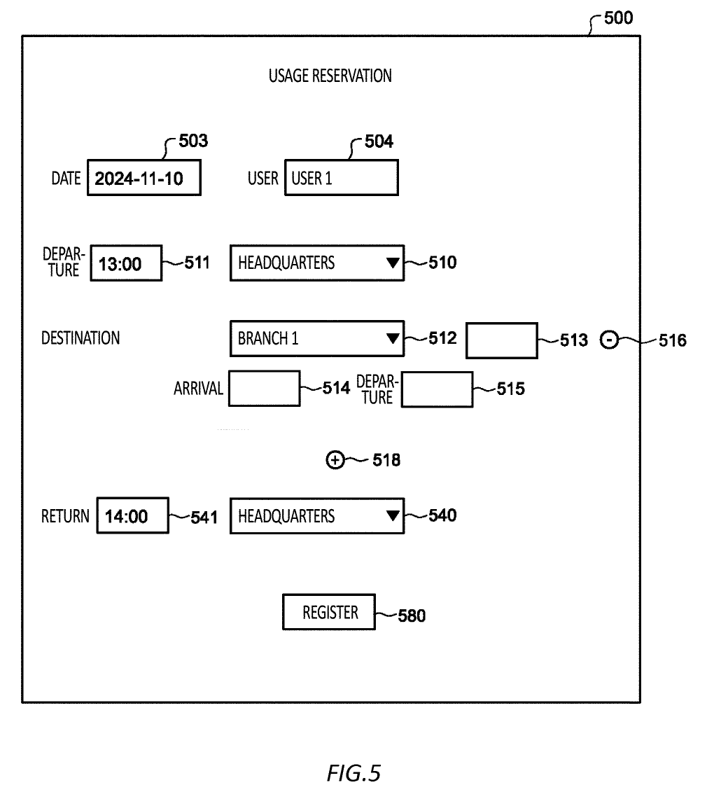

FIG. 5 illustrates a screen 500 that provides a user interface provided to the user 20. The screen 500 is an example of a reservation screen provided through the terminal 22 when the user 20 is to input reservation information on the vehicle 10.

The screen 500 is displayed on the terminal 22 via control by the presentation control unit 230. The presentation control unit 230 causes a user interface screen, such as the screen 500, to be displayed on the terminal 22 by causing data and/or a program needed for the terminal 22 to display the user interface screen to be transmitted to the terminal 22 through the communication unit 290. The screen 500 includes an input box 503, a display box 504, an input box 511, a selection menu 510, a selection menu 512, an input box 513, a display box 514, a display box 515, a button 516, a button 518, an input box 541, a selection menu 540, and a button 580. The button 580 is an object for transmitting information input through the screen 500 to the vehicle management apparatus 60 as the reservation information. The input box 511, the input box 513, and the input box 541 are examples of input fields presented for each input item. On the terminal 22, the input box 511, the input box 513, and the input box 541 are displayed simultaneously or substantially simultaneously according to the data and/or the program transmitted to the terminal 22 via control by the presentation control unit 230.

The screen 500 includes the input box 503 for inputting a date to reserve the vehicle 10. The screen 500 includes the display box 504 for displaying a user of the vehicle 10.

The screen 500 includes the selection menu 510 for selecting a departure point, and the input box 511 for inputting a departure time. The departure point corresponds to the scheduled departure location of the vehicle 10. The departure time indicates the scheduled departure time of the vehicle 10. The departure time corresponds to the usage start time of the vehicle 10. The departure time is an example of the input items on the time at which, or the duration for which the vehicle 10 travels. The departure time and the date define a scheduled departure time and date as an example of the scheduled departure time.

The screen 500 includes the selection menu 512 for selecting a spot which is a first destination (waypoint). The first destination corresponds to the first location scheduled as the travel destination of the vehicle 10. The screen 500 includes the button 518 for adding a second destination and the button 516 for deleting the first destination.

The screen 500 includes the input box 513 for inputting a stay duration at the first destination. The stay duration is an example of the plurality of input items on the time at which, or the duration for which the vehicle 10 travels.

The screen 500 includes the display box 514 for displaying a scheduled arrival time indicating a scheduled time at which the vehicle 10 arrives at the first destination. The screen 500 includes a display box 515 for displaying a scheduled departure time indicating a scheduled time at which the vehicle 10 departs the first destination.

The screen 500 includes the selection menu 540 for selecting the return point and the input box 541 for inputting the return time at which the vehicle 10 arrives at the return point. The return point is a spot at which the user finally arrives using the vehicle 10. That is, this is a spot at which the user finishes using the vehicle 10. The return point corresponds to the scheduled return location of the vehicle 10. The return time indicates the scheduled return time of the vehicle 10. The return time corresponds to a usage end time of the vehicle 10. The return time is an example of the input items on the time at which, or the duration for which the vehicle 10 travels. The return time and the date define a scheduled return time and date as an example of the scheduled return time.

The screen 500 shows that the user 20 has selected a time and date, a departure point, a first destination, and a return point, and has input a departure time and a return time through the terminal 22. Every time a departure point, a first destination, and a return point are selected respectively through the selection menu 510, the selection menu 512, and the selection menu 540, the terminal 22 transmits information thus selected to the vehicle management apparatus 60.

The location-information acquisition unit 260 of the vehicle management apparatus 60 acquires the departure point, the first destination, and the return point based on the information transmitted from the terminal 22. In this manner, the location-information acquisition unit 260 acquires location information that includes information indicating the scheduled departure location of the vehicle 10, travel destination information indicating the first location scheduled as the travel destination of the vehicle 10, and information indicating the scheduled return location of the vehicle 10. The required duration acquisition unit 262 acquires required duration information indicating a duration required for the vehicle 10 to travel, calculated based on the location information acquired by the location-information acquisition unit 260. The required duration information includes a first required duration, which is required for the vehicle 10 to travel from the departure point to the first destination, and a second required duration, which is required for the vehicle 10 to travel from the first destination to the return point.

For example, the required duration acquisition unit 262 may decide a path from the departure point to the first destination and a path from the first destination to the return point, and calculate a duration required for the vehicle 10 to drive along each of the paths thus decided. The required duration acquisition unit 262 may transmit information indicating the departure point, the first destination, and the return point, to an external server which calculates a required duration based on the departure point, the first destination and the return point, and acquire, from the external server, information indicating the required duration calculated by the external server.

Every time information is input into each of the input box 511, the input box 513, and the input box 541, the terminal 22 transmits the information thus input to the vehicle management apparatus 60. The accepting unit 250 of the vehicle management apparatus 60 accepts the information transmitted from the terminal 22. In this manner, the accepting unit 250 accepts information that has been input into the plurality of input items on the time at which, or the duration for which the vehicle 10 travels. In an example of FIG. 5, the input items are three input items of the departure time, the stay duration at the first destination, and the return time. With reference to FIG. 5, etc., the stay duration at the first destination may be called the "stay duration".

In the vehicle management apparatus 60, when the accepting unit 250 accepts the information, the determination unit 242 determines that information has been input into a predefined number of at least one input item among the plurality of input items. In an example of the screen 500, the determination unit 242 determines that information has been input into two input items among the three input items. In the vehicle management apparatus 60, the calculation unit 240, when the determination unit 242 determines that information has been input into the predefined number of at least one of input item, calculates information on at least one input item into which no information has been input among the plurality of input items, based on the information that has been input into the predefined number of at least one input item having the information input thereinto, the location information, and the required duration information. In an example of the screen 500, the input item into which no information has been input is the stay duration. That is, the determination unit 242 determines that information has been input into the two input items of the departure time and the return time, and the calculation unit 240 calculates information on the stay duration into which no information has been input, based on the information that has been input into the input items of the departure time and the return time and the required duration information acquired by the required duration acquisition unit 262. The presentation control unit 230 generates calculation information that includes information indicating the stay duration calculated by the calculation unit 240, instruction information that the stay duration is to be highlighted, and the required duration information acquired by the required duration acquisition unit 262, and causes the calculation information thus generated to be transmitted to the communication unit 290 through the terminal 22.

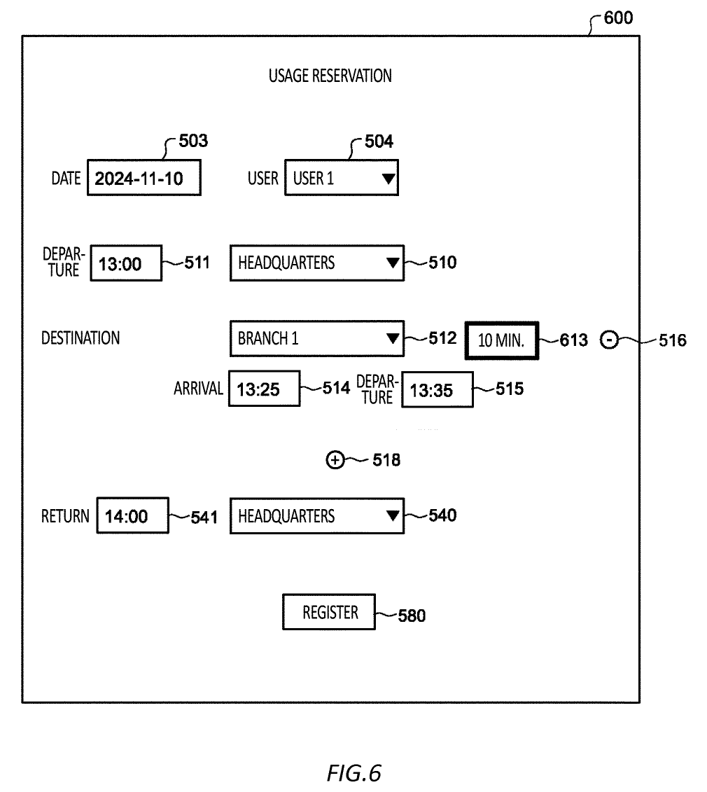

FIG. 6 illustrates a screen 600 that provides the user interface provided to the user 20. The screen 600 shows that the stay duration calculated by the calculation unit 240 of the vehicle management apparatus 60 has been input into an input box for the stay duration.

The terminal 22, when receiving the calculation information transmitted from the vehicle management apparatus 60, as shown on the screen 600, causes the stay duration included in the calculation information thus received to be input into the input box 613. Further, the terminal 22 causes the input box 613 to be highlighted based on the instruction information included in the calculation information. In this manner, the presentation control unit 230 of the vehicle management apparatus 60 performs control for causing an input field that corresponds to an input item for which the calculation unit 240 is to calculate the information, among the plurality of input fields, to present that the calculation unit 240 is to calculate the information. To "highlight” is an example of presenting that "the calculation unit 240 is to calculate the information”.

The terminal 22 calculates an arrival time at the first destination based on the required duration information included in the calculation information, and causes the arrival time thus calculated to be displayed in the display box 514. For example, the terminal 22 calculates, as the arrival time at the first destination, a time obtained by adding the required duration from the departure point to the first destination to the departure time at the departure point. Further, the terminal 22 calculates a departure time from the first destination based on the required duration information included in the calculation information and the stay duration included in the calculation information, and causes the departure time thus calculated to be displayed in the display box 515. For example, the terminal 22 calculates, as the departure time from the first destination, a time obtained by adding the stay duration to the arrival time at the first destination.

On the screen 600, when a register button 580 is pressed, the terminal 22 transmits, to the vehicle management apparatus 60, reservation information that includes information input on the screen 600. In the vehicle management apparatus 60, when the acquisition unit 210 acquires the reservation information transmitted from the terminal 22, the decision unit 220 decides an operation plan of the vehicle 10 based on the reservation information acquired by the acquisition unit 210.

As described with reference to FIG. 5, FIG. 6, etc., the information processing by the vehicle management apparatus 60 allows the user 20 to input information into the two input items of the departure time and the return time in the user interface displayed on the terminal 22, with the departure point, the destination, and the return point having been input, to cause the stay duration calculated in the vehicle management apparatus 60 to be automatically input. This allows the user 20 to save the effort of inputting the stay duration, enabling easy and prompt input of the reservation information for the user 20.

In the example of FIG. 5 and FIG. 6, a case has been described in which, when the three input items to be input includes the departure time at the departure point, the stay duration at the first destination, and the return time to the return point, when information is input into the two input items of d the departure time and the return time, then the calculation unit 240 of the vehicle management apparatus 60 automatically calculates the stay duration. However, when information is input into two input items of the departure time and the stay duration, then the calculation unit 240 may automatically calculate the return time. When information is input into two input items of the return time and the stay duration, then the calculation unit 240 may automatically calculate the departure time. In this manner, when information is input into any two input items among the departure time, the stay duration, and the return time, then the calculation unit 240 may automatically calculate information on another input item into which no information has been input.

In another embodiment, when information is input into any one input item among the departure time, the stay duration, and the return time, then the calculation unit 240 may automatically calculate information on other two input items into which no information has been input. As an example, when information is input into the input item of the departure time, then the calculation unit 240 may calculate the return time based on the departure time indicated by the information thus input, a predefined stay duration, and the required duration information. The predefined stay duration may be, for example, five minutes. The predefined stay duration may be a duration set for each user 20, for each destination, and/or for each type of destination. Examples of types of destinations may include a retail store (for example, a convenience store, a supermarket, and so on), an office, and the like. The predefined stay duration may have been input into the input box 513 on the screen 500 when the screen 500 is displayed. The presentation control unit 230 may generate calculation information that includes the return time calculated by the calculation unit 240, the predefined stay duration, instruction information that the return time and the stay duration are to be highlighted, and cause the calculation information thus generated to be transmitted to the terminal 22 through the communication unit 290.

As another example, when information is input into the input item of the return time, then the calculation unit 240 may calculate the departure time based on the return time which is indicated by the information thus input, the predefined stay duration, and the required duration information. As still another example, when information is input into the input item of the stay duration, then the calculation unit 240 may calculate the return time based on the stay duration which is indicated by the information thus input, the predefined departure time, and the required duration information. As still another example, when information is input into the input item of the stay duration, then the calculation unit 240 may calculate the departure time based on the stay duration which is indicated by the information thus input, the predefined return time, and the required duration information. The predefined departure time and/or the predefined return time may be a time set for each user 20.

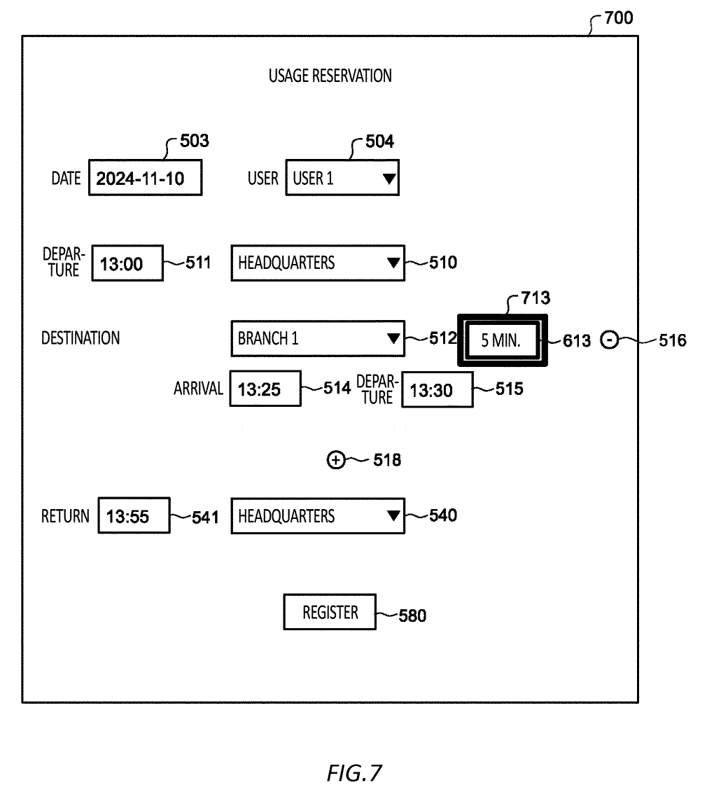

FIG. 7 illustrates a screen 700 that provides the user interface provided to the user 20. The screen 700 illustrates a reporting screen when the stay duration calculated by the calculation unit 240 of the vehicle management apparatus 60 satisfies a predefined condition.

The screen 700 is a reporting screen when a return time that is five minutes earlier than the return time displayed on the screen 500 has been input. In this case, the calculation unit 240 of the vehicle management apparatus 60 calculates a stay duration that is five minutes shorter than the stay duration displayed on the screen 500. When the stay duration calculated by the calculation unit 240 satisfies a predefined condition regarding the stay duration, the reporting control unit 270 generates calculation information that includes warning information regarding the stay duration. For example, the predefined condition regarding the stay duration may include a condition that the stay duration is equal to or less than a predefined duration (for example, five minutes). Based on the warning information included in the calculation information, the terminal 22 causes a warning object 713 to be displayed to perform warning regarding the stay duration. The predefined duration regarding the stay duration may be any value equal to or greater than zero minutes. The predefined duration regarding the stay duration may be set for each user 20. In this manner, the predefined condition regarding the stay duration may be set for each user 20.

With reference to FIG. 7, although an embodiment has been described in which reporting is performed when the stay duration calculated by the calculation unit 240 satisfies the predefined condition, reporting may be performed when information of at least one of the departure time or the return time calculated by the calculation unit 240 satisfies a predefined condition. For example, when the departure time calculated by the calculation unit 240 satisfies a predefined condition regarding the departure time, the reporting control unit 270 may generate calculation information that includes warning information regarding the departure time. The predefined condition regarding the departure time may include a condition that the departure time is earlier than a predefined time (for example, 6 a.m.). When the return time calculated by the calculation unit 240 satisfies a predefined condition regarding the return time, the reporting control unit 270 may generate calculation information that includes warning information regarding the return time. The predefined condition regarding the return time may include a condition that the return time is later than a predefined time (for example, 8 p.m.). In this manner, the reporting control unit 270 performs control for performing reporting when information calculated by the calculation unit 240 satisfies a predefined condition. The predefined condition may be set for each of the plurality of input items.

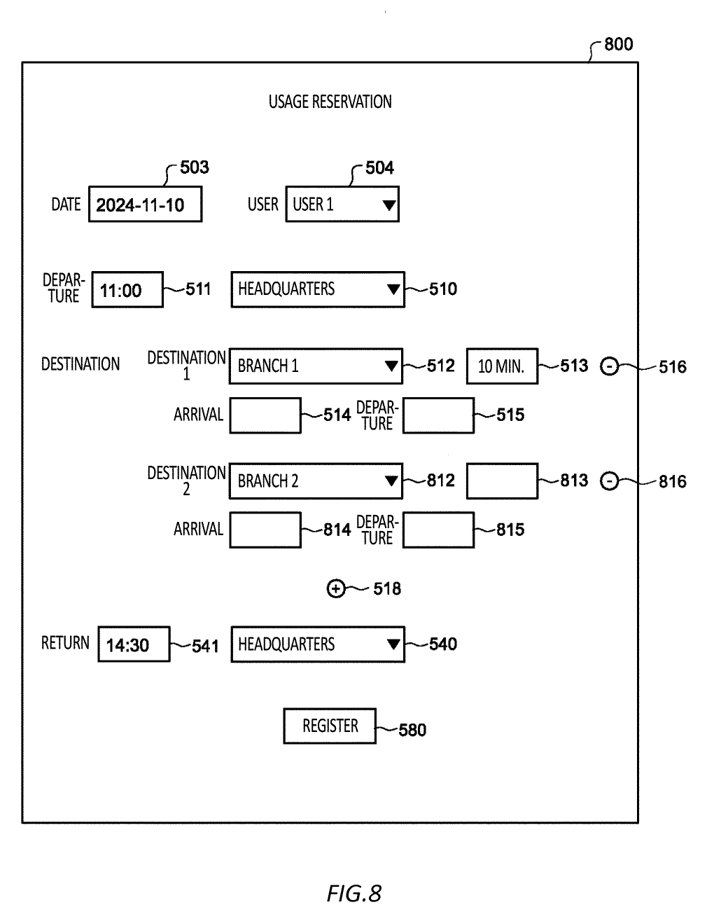

FIG. 8 illustrates a screen 800 that provides the user interface provided to the user 20. The screen 800 is a screen for making a reservation in which the vehicle 10 is to return via two destinations.

The screen 800 is displayed on the terminal 22 via control by the presentation control unit 230. The screen 800 further includes a selection menu 812, an input box 813, a display box 814, and a display box 815 in addition to the objects displayed on the screen 500 as illustrated in FIG. 5. The input box 511, the input box 513, the input box 813, and the input box 541 are examples of input fields presented for each input item. On the terminal 22, the input box 511, the input box 513, the input box 813, and the input box 541 are displayed simultaneously or substantially simultaneously according to the data and/or the program transmitted to the terminal 22 via control by the presentation control unit 230.

The selection menu 812 is a menu for selecting a spot which is a second destination (waypoint). The second destination corresponds to the second location scheduled as the travel destination of the vehicle 10. The screen 800 includes a button 816 for deleting the second destination.

The input box 813 is an object for inputting a stay duration at the second destination. The stay duration is an example of the plurality of input items on the time at which, or the duration for which the vehicle 10 travels.

The display box 514 is an object in which a scheduled arrival time indicating a scheduled time at which the vehicle 10 arrives at the second destination is displayed. The display box 815 is an object in which a scheduled departure time indicating a scheduled time at which the vehicle 10 departs the second destination is displayed.

The screen 800 shows that the user 20, through the terminal 22, has selected a time and date, a departure point, a first destination, a second destination, and a return point, and has input a departure time, a return time, and a stay duration at the first destination. Every time a departure point, a first destination, a second destination, and a return point are selected respectively through the selection menu 510, the selection menu 512, the selection menu 812, and the selection menu 540, the terminal 22 transmits the information thus selected to the vehicle management apparatus 60.

The location-information acquisition unit 260 of the vehicle management apparatus 60 acquires the departure point, the first destination, the second destination, and the return point based on the information transmitted from the terminal 22. In this manner, the location-information acquisition unit 260 acquires location information that includes information indicating a scheduled departure location of the vehicle 10, travel destination information indicating a first location scheduled as the travel destination of the vehicle 10, travel destination information indicating a second location scheduled as the travel destination of the vehicle 10, and information indicating a scheduled return location of the vehicle 10. The required duration acquisition unit 262 acquires required duration information indicating a duration required for the vehicle 10 to travel, calculated based on the location information acquired by the location-information acquisition unit 260. The required duration information includes a first required duration which is required for the vehicle 10 to travel from the departure point to the first destination, a third required duration which is required for the vehicle 10 to travel between the first destination and the second destination, and a fourth required duration which is required for the vehicle 10 to travel from the second destination to the return point.

The required duration acquisition unit 262 may decide a path from the departure point to the first destination, a path from the first destination to the second destination, and a path from the second destination to the return point, and may calculate a duration required for the vehicle 10 to drive along each of the paths thus decided. The required duration acquisition unit 262 may transmit the second destination, and the return point, information indicating the departure point, the first destination, the second destination, and the return point, to an external server that calculates a required duration based on the departure point, the first destination, and may acquire, from the external server, information indicating a required duration calculated by the external server.

Every time information is input into each of the input box 511, the input box 513, the input box 813, and the input box 541, the terminal 22 transmits the information thus input to the vehicle management apparatus 60. The accepting unit 250 of the vehicle management apparatus 60 accepts the information transmitted from the terminal 22. In this manner, the accepting unit 250 accepts information that has been input into the plurality of input items on the time at which, or the duration for which the vehicle 10 travels. In the example of FIG. 8, the input items are four input items of the departure time, the stay duration at the first destination, the stay duration at the second destination, and the return time.

In the vehicle management apparatus 60, when the accepting unit 250 accepts the information, the determination unit 242 determines that information has been input into a predefined number of at least one input item among the plurality of input items. In an example of the screen 800, the determination unit 242 determines that information has been input into three input items among the four input items. In the vehicle management apparatus 60, the calculation unit 240, when the determination unit 242 determines that information has been input into the predefined number of at least one of input item, calculates information on at least one input item, into which no information has been input among the plurality of input items, based on the information that has been input into the predefined number of at least one input item having the information input thereinto, the location information, and the required duration information. In the example of the screen 800, the input item into which no information has been input is the stay duration at the second destination. That is, the determination unit 242 determines that information has been input into the three input items of the departure time, the stay duration at the first destination, and the return time, and the calculation unit 240 calculates information on the stay duration at the second destination into which no information has been input, based on the information that has been input into the input items of the departure time, the stay duration at the first destination, and the return time and the required duration information acquired by the required duration acquisition unit 262. The presentation control unit 230 generates calculation information that includes information indicating the stay duration at the second destination calculated by the calculation unit 240, instruction information that the stay duration at the second destination is to be highlighted, and the required duration information acquired by the required duration acquisition unit 262, and causes the calculation information thus generated to be transmitted to the terminal 22 through the communication unit 290.

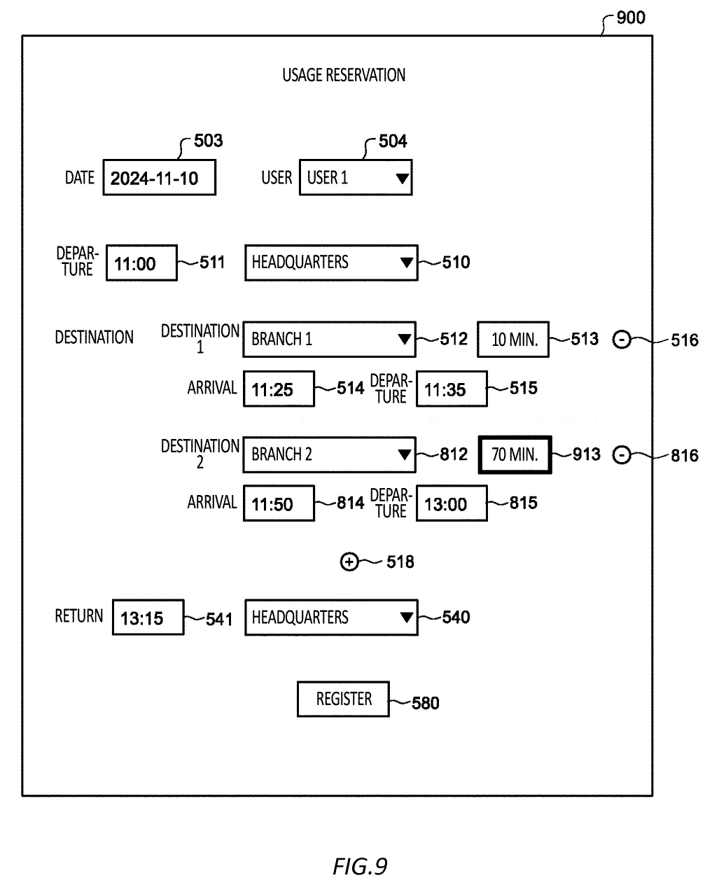

FIG. 9 illustrates a screen 900 that provides the user interface provided to the user 20. The screen 900 shows that the stay duration at the second destination calculated by the calculation unit 240 of the vehicle management apparatus 60 has been input into an input box for the stay duration in question.

The terminal 22, when receiving the calculation information transmitted from the vehicle management apparatus 60, as shown on the screen 900, causes the stay duration at the second destination included in the calculation information thus received to be input into the input box 913. Further, the terminal 22 causes the input box 913 to be highlighted based on the instruction information included in the calculation information. In this manner, the presentation control unit 230 of the vehicle management apparatus 60 performs control for causing an input field that corresponds to an input item for which the calculation unit 240 is to calculate the information, among the plurality of input fields, to present that the calculation unit 240 is to calculate the information. To "highlight” is an example of presenting that "the calculation unit 240 is to calculate the information”.

The terminal 22 calculates an arrival time at the second destination based on the required duration information included in the calculation information, and causes the arrival time thus calculated to be displayed in the display box 814. For example, the terminal 22 calculates, as the arrival time at the second destination, a time obtained by adding the required duration from the first destination to the second destination to the departure time from the first destination. Further, the terminal 22 calculates a departure time from the second destination based on the required duration information included in the calculation information and the stay duration at the second destination included in the calculation information, and causes the departure time thus calculated to be displayed in the display box 815. For example, the terminal 22 calculates, as the departure time from the second destination, a time obtained by adding the stay duration at the second destination to the arrival time at the second destination.

On the screen 800, when the register button 580 is pressed, the terminal 22 transmits, to the vehicle management apparatus 60, reservation information that includes information input on the screen 800. In the vehicle management apparatus 60, when the acquisition unit 210 acquires the reservation information transmitted from the terminal 22, the decision unit 220 decides an operation plan of the vehicle 10 based on the reservation information acquired by the acquisition unit 210.

As described with reference to FIG. 8, FIG. 9, etc., the information processing by the vehicle management apparatus 60 allows the user 20 to input information into the three input items of the departure time, the first destination, and the return time in the user interface displayed on the terminal 22, with the departure point, the first destination, the second destination, and the return point having been input, to cause the stay duration at the second destination calculated in the vehicle management apparatus 60 to be automatically input. This allows the user 20 to save the effort of inputting the stay duration at the second destination, enabling easy and prompt input of the reservation information for the user 20.

In the examples of FIG. 8 and FIG. 9, a case has been described in which, when the four input items to be input includes the departure time at the departure point, the stay duration at the first destination, the stay duration at the second destination, and the return time to the return point, when information is input into the three input items of the departure time, the stay duration at the first destination, and the return time, then the calculation unit 240 of the vehicle management apparatus 60 automatically calculates the stay duration. However, when information is input into three input items of the departure time, the stay duration at the second destination, and the return time, then the calculation unit 240 may automatically calculate the stay duration at the first destination. When information is input into three input items of the departure time, the stay duration at the first destination, and the stay duration at the second destination, then the calculation unit 240 may automatically calculate the return time. When information is input into three input items of the return time, the stay duration at the first destination, and the stay duration at the second destination, then the calculation unit 240 may automatically calculate the departure time. In this manner, when information is input into any three input items among the departure time, the stay duration at the first destination, the stay duration at the second destination, and the return time, then the calculation unit 240 may automatically calculate information on another input item into which no information has been input.

In another embodiment, when information is input into any M input item(s) among the departure time, the stay duration at the first destination, the stay duration at the second destination, and the return time, then the calculation unit 240 may automatically calculate information on the other (4 - M) input item(s) into which no information has been input. As an example where M = 2, when information is input into the input items of the departure time and the return time, then the calculation unit 240 may calculate the stay duration at the first destination and the stay duration at the second destination based on a departure time and a return time which are indicated by the information thus input, and the required duration information. The calculation unit 240 may calculate the stay duration at the first destination and the stay duration at the second destination based on a total stay duration obtained by subtracting a traveling duration of the vehicle 10 (that is, a total duration of the required duration from the departure point to the first destination, the required duration from the first destination to the second destination, and the required duration from the second destination to the return point), from a duration between the departure time and the return time. The calculation unit 240 may decide, as the stay duration at the first destination and the stay duration at the second destination, a duration obtained by dividing the total stay duration by a number of destinations (two, in FIG. 9). The presentation control unit 230 generates calculation information that includes the stay duration at the first destination and the stay duration at the second destination calculated by the calculation unit 240, and instruction information that the stay durations in question are to be highlighted, and may cause the calculation information thus generated to be transmitted to the terminal 22 through the communication unit 290.

As another example where M = 2, when information is input into the input items of the departure time and the stay duration at the first destination, then the calculation unit 240 may calculate the return time based on the departure time and the stay duration at the first destination which are indicated by the information thus input, and a predefined stay duration at the second destination and the required duration information. The predefined stay duration at the second destination may be, for example, five minutes. The predefined stay duration at the second destination may be a duration set for each user 20, for each destination, and/or for each type of destination. Examples of types of destinations may include a retail store (for example, a convenience store, a supermarket, and so on), an office, and the like. The presentation control unit 230 may generate calculation information that includes the return time calculated by the calculation unit 240, the predefined stay duration at the second destination, instruction information that the return time and the stay duration at the second destination are to be highlighted, and cause the calculation information thus generated to be transmitted to the terminal 22 through the communication unit 290.

As another example where M = 2, when information is input into the input items of the return time and the stay duration at the first destination, then the calculation unit 240 may calculate the departure time based on the return time which is indicated by the information thus input, a predefined stay duration at the second destination, and the required duration information. As still another example where M = 2, when information is input into the input items of the stay duration at the first destination and the stay duration at the second destination, then the calculation unit 240 may calculate the return time based on the stay duration at the first destination and the stay duration at the second destination which are indicated by the information thus input, a predefined departure time, and the required duration information. As still another example where M = 2, when information is input into the input items of the stay duration at the first destination and the stay duration at the second destination, then the calculation unit 240 may calculate the departure time based on the stay duration at the first destination and the stay duration at the second destination which are indicated by the information thus input, a predefined return time, and the required duration information. The predefined departure time and/or the predefined return time may be a time set for each user 20.

As an example where M = 1, when information is input into the input item of the departure time, then the calculation unit 240 may calculate the return time based on the departure time which is indicated by the information thus input, a predefined stay duration at the first destination, a predefined stay duration at the second destination, and the required duration information. The predefined stay duration at the first destination and the predefined stay duration at the second destination may be, for example, five minutes. The predefined stay duration at the first destination and the predefined stay duration at the second destination may be durations set for each user 20 and/or for each destination. The presentation control unit 230 generates calculation information that includes the return time calculated by the calculation unit 240, the predefined stay duration at the first destination, the predefined stay duration at the second destination, and instruction information that the return time and the stay durations are to be highlighted, and may cause the calculation information thus generated to be transmitted to the terminal 22 through the communication unit 290. As another example where M = 1, when information is input into the input item of the return time, then the calculation unit 240 may calculate the departure time based on the return time which is indicated by the information thus input, a predefined stay duration at the first destination, a predefined stay duration at the second destination, and the required duration information.

As described in the specific examples with reference to FIG. 5 to FIG. 9, when information is input into M input item(s) among N input items, where M is less than N, then the calculation unit 240 may automatically calculate information on at least one input item among other (N - M) input item(s) into which no information has been input. Here, M may be 2 or more, or M may be 1 or more.

With reference to FIG. 6 to FIG. 9 etc., although an embodiment has been described in which the vehicle management apparatus 60 includes functions of the accepting unit 250, the determination unit 242, and the calculation unit 240, at least a part of the functions of the accepting unit 250, the determination unit 242, and the calculation unit 240 may be implemented on the terminal 22. For example, the vehicle management apparatus 60 causes a program for implementing at least a part of the functions of the accepting unit 250, the determination unit 242, and the calculation unit 240 to be transmitted to the terminal 22 as a part of a program to cause the terminal 22 to display a user interface screen, and by the terminal 22 executing the program, at least a part of the functions of the accepting unit 250, the determination unit 242, or the calculation unit 240 may be implemented on the terminal 22.

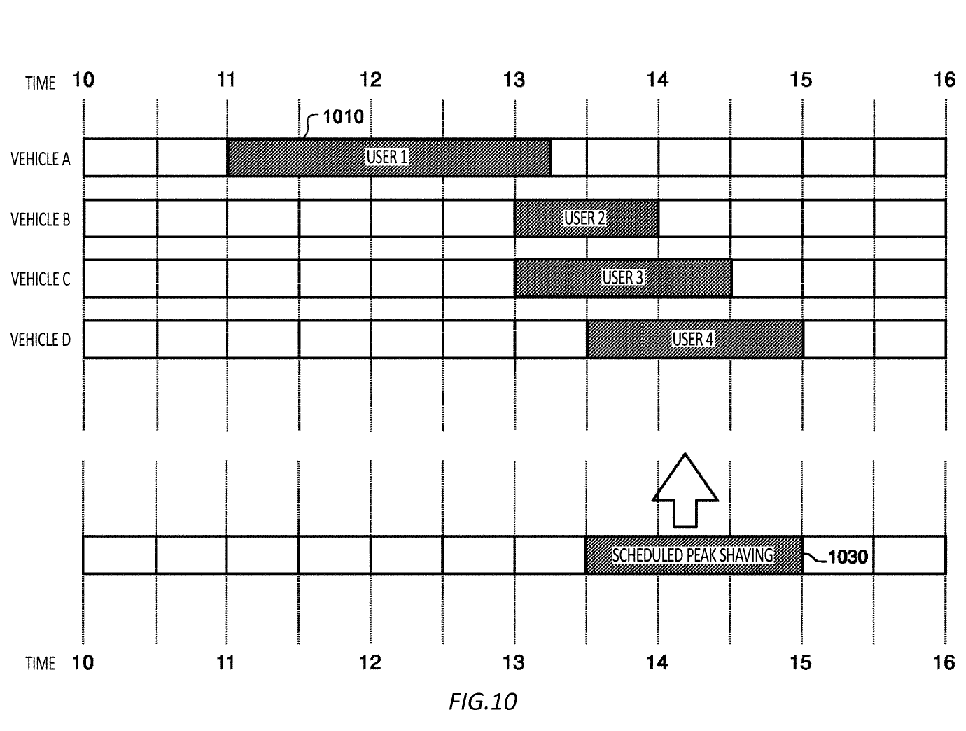

FIG. 10 illustrates arbitration of an operation plan of a vehicle 10 and an electricity plan in an office 30. The operation plan includes a user who uses the vehicle 10 and a time period for which the user in question uses the vehicle 10, which are decided by the decision unit 220. In the operation plan shown in FIG. 10, as indicated by reference numeral 1010, it is decided that a user 1 uses a vehicle A from 11 a.m. to 1:15 p.m., a user 2 uses a vehicle B from 1 p.m. to 2 p.m., a user 3 uses a vehicle C from 1 p.m. to 2:30 p.m., and a user 4 uses a vehicle D from 1:30 p.m. to 3 p.m.

The electricity plan includes information indicating a time period for which electric power is to be provided from the vehicle 10, and an amount of electric power that is to be provided from the vehicle 10 per unit time (e.g., a half-hourly amount of electric power). In the electricity plan shown in FIG. 10, in order to cause power consumption in the office 30 to be a predefined value or less, it is decided, as indicated by reference numeral 1030, that electric power is to be provided from any of the vehicle(s) 10 to the office 30 between 1:30 p.m. and 3 p.m.

The integrated management apparatus 50 arbitrates the operation plan generated by the vehicle management apparatus 60 and the electricity plan generated by the power control apparatus 40. The arbitration by the integrated management apparatus 50 may be performed at a timing earlier by a predefined duration than a predefined time on the target date of the operation plan and the electricity plan. For example, the timing at which the arbitration by the integrated management apparatus 50 is performed may be 7 a.m. on a day before the target date of the operation plan and the electricity plan.

When the integrated management apparatus 50 is to perform arbitration, the acquisition unit 310 of the integrated management apparatus 50 acquires, from the vehicle management apparatus 60 and the power control apparatus 40, an operation plan and an electricity plan, respectively. In the vehicle management apparatus 60, the decision unit 340, based on the electricity plan and the operation plan, decides: that the vehicle A is the vehicle 10 which is to provide electric power to the office 30; that a time period from 1:30 p.m. to 3 p.m. is a time period for which electric power is to be provided from the vehicle A; and an amount of electric power that is to be provided from the vehicle A per unit time for the time period in question (e.g., a half-hourly amount of electric power). The communication unit 390 transmits to the vehicle management apparatus 60, information for identifying the vehicle 10 which is to provide electric power to the office 30, information indicating the time period for which electric power is to be provided from the vehicle A and the amount of electric power per unit time that is to be provided from the vehicle A, as a part of the result of the arbitration.

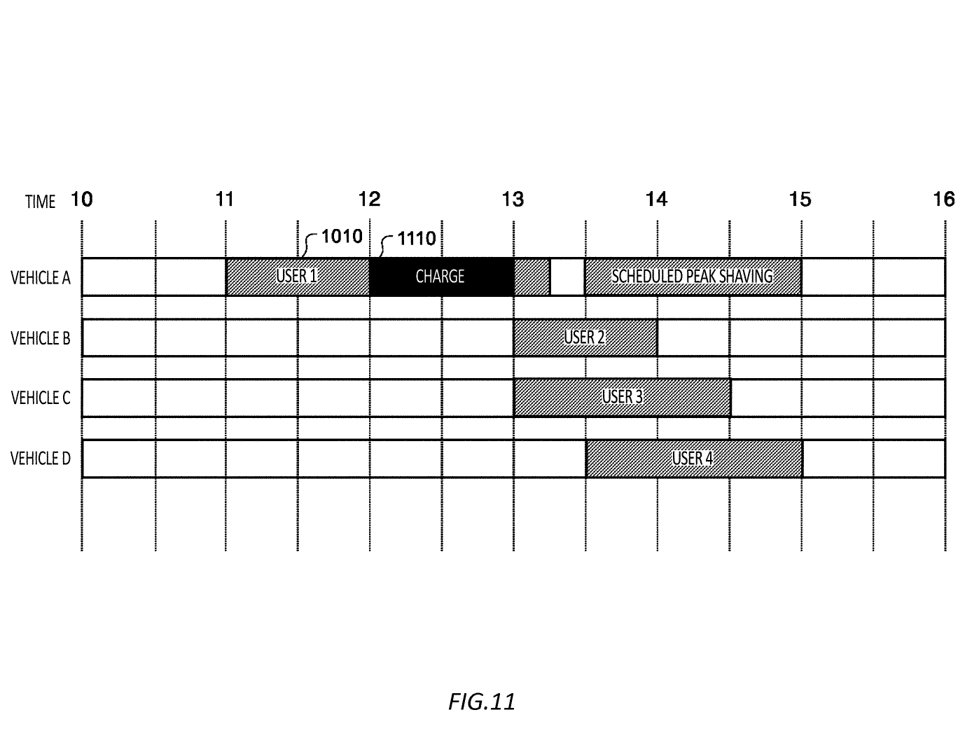

FIG. 11 illustrates the operation plan of the vehicle 10 after being arbitrated by the integrated management apparatus 50. The acquisition unit 210 of the vehicle management apparatus 60 acquires information indicating the result of the arbitration by the integrated management apparatus 50. In the computation unit 200, the decision unit 220 predicts a transition of an SOC of the battery 12 of the vehicle A based on a predicted value of the SOC of the vehicle A at 11 a.m. on a target date, a predicted value of an amount of decrease in the SOC of the vehicle A due to the vehicle A driving between 11 a.m. and 1:15 p.m. on the target date, and a time period that electric power is to be provided from the vehicle A and an amount of electric power per unit time represented by the result of the arbitration.

The decision unit 220 decides, based on the predicted transition of the SOC of the battery 12 of the vehicle A, a charge-and-discharge plan of the battery 12 of the vehicle A. Specifically, the decision unit 220 decides a time period for which the battery 12 of the vehicle A is to be charged and/or discharged, and an amount of electric power to be charged and/or an amount of electric power to be discharged from the battery 12 of the vehicle A. In the example of FIG. 11, when it is predicted that the SOC of the battery 12 of the vehicle A falls below a predefined value, the decision unit 220 decides a time period for which the battery 12 of the vehicle A is to be charged and an amount of electric power to be charged into the battery 12 of the vehicle A. In the example shown in FIG. 11, as indicated by reference sign 1110, the decision unit 220 decides that the vehicle A is to be charged from 12 p.m. to 1 p.m. on a target date. In this case, the communication unit 290 notifies the user 20 corresponding to the user 1 that the vehicle A is to be charged at a charge-and-discharge station at a branch 2 or near the branch 2 from 12 p.m. to 1 p.m. Furthermore, when the vehicle management apparatus 60 receives, from the terminal 22, a presentation request for the usage plan of the vehicle 10 by the user 20 corresponding to the user 1, the vehicle management apparatus 60 performs control to present, to the user 20 corresponding to the user 1 through the terminal 22, that the vehicle A is to be charged at the charge-and-discharge station at the branch 2 or near the branch 2 between 12 p.m. and 1 p.m.

In this manner, the computation unit 200 in the integrated management apparatus 50 predicts, based on reservation information indicating a usage reservation of the vehicle 10, a transition of an amount of electric power accumulated in the battery 12 equipped in the vehicle 10. The computation unit 200 performs, based on the information that has been input into the plurality of input items and the information calculated by the calculation unit 240, processing for electric power exchange between the vehicle 10 and the outside of the vehicle 10 at the first location and/or the second location.

With reference to FIG. 10 and FIG. 11, a case has been described in which the integrated management apparatus 50 and the vehicle management apparatus 60 perform processing for electric power exchange between the vehicle 10 and the outside of the vehicle 10 within a stay duration at a scheduled destination. However, in the integrated management apparatus 50 and the vehicle management apparatus 60, in order to perform electric power exchange between the vehicle 10 and the outside of the vehicle 10, adjustment of the departure time of the vehicle 10, adjustment of the stay duration at the destination, and/or adjustment of the return time of the vehicle 10 may be performed.

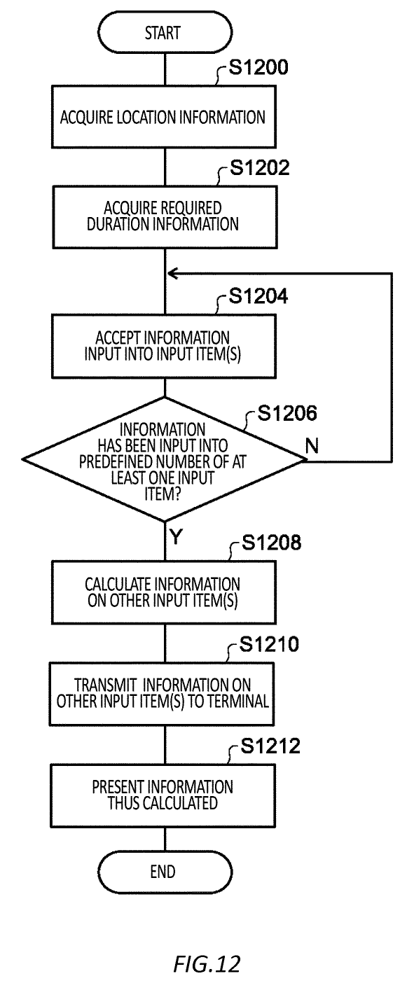

FIG. 12 is a flowchart of information processing for a travel schedule of the vehicle 10 executed by the system 5.

In S1200, the location-information acquisition unit 260 acquires location information that includes information indicating the departure point of the vehicle 10, information indicating the destination of the vehicle 10, and information indicating the return point of the vehicle 10. For example, as described with reference to FIG. 5, FIG. 8, etc., the location-information acquisition unit 260 acquires location information that has been input into the terminal 22 and transmitted from the terminal 22.

In S1202, the required duration acquisition unit 262 acquires required duration information indicating the duration required for the vehicle 10 to travel, calculated based on the location information acquired in S1200. Specifically, the required duration acquisition unit 262 may identify a path along which the vehicle 10 drives based on the information indicating the departure point of the vehicle 10, the information indicating the destination of the vehicle 10, and the information indicating the return point of the vehicle 10, and may calculate a duration required for the vehicle 10 to drive along the path thus identified. The required duration acquisition unit 262 may transmit information indicating the departure point of the vehicle 10, information indicating the destination of the vehicle 10, and information indicating the return point of the vehicle 10 to an external server that calculates a required duration, and may acquire, from the external server, information indicating the required duration calculated by the external server.

In S1204, the accepting unit 250 accepts information that has been input into a plurality of input items on a time at which, or a duration for which the vehicle 10 travels. For example, as described with reference to FIG. 5, FIG. 8, etc., the accepting unit 250 acquires information that has been input into any of input item(s) of the departure time, the stay duration, and the return time of the vehicle 10, which are input into the terminal 22 and transmitted from the terminal 22.

In S1206, the determination unit 242 determines whether or not input has been made into a predefined number of at least one input item. When the determination unit 242 determines in S1206 that input has not been made into the predefined number of at least one input item, processing proceeds to S1204. When the determination unit 242 determines in S1206 that input has been made into the predefined number of at least one input item, in S1208, then the calculation unit 240 calculates, based on the information on the predefined number of at least one input item into which information has been input and the required duration information acquired in S1202, information on at least one input item among the plurality of input items into which no information has been input.

In S1210, the communication unit 290 of the vehicle management apparatus 60 transmits calculation information that includes the information calculated in S1208 to the terminal 22. In S1212, the terminal 22 displays, based on the calculation information transmitted from the vehicle management apparatus 60 in S1210, the information calculated in S1208.

The system 5 described above allows the user 20 to input information on some, not all, of the input items among the input items of the departure time, the stay duration at one or more destinations, and the return time, to cause information on some of other input items to be calculated for making a usage reservation of the vehicle 10. This allows information exchange required for operation management of the vehicle 10 to be reduced. For the user 20, the effort of inputting information on some of the input items can be saved, enabling easy and prompt input of the reservation information of the vehicle 10 for the user 20.

In the above description, an embodiment has been described in which the vehicle management apparatus 60 and the integrated management apparatus 50 cooperate to implement, as an information processing apparatus, functions that perform information processing for the travel schedule of the vehicle 10. However, as another embodiment, an embodiment may be employed in which functions of the vehicle management apparatus 60 and the integrated management apparatus 50 are implemented by one information processing apparatus.

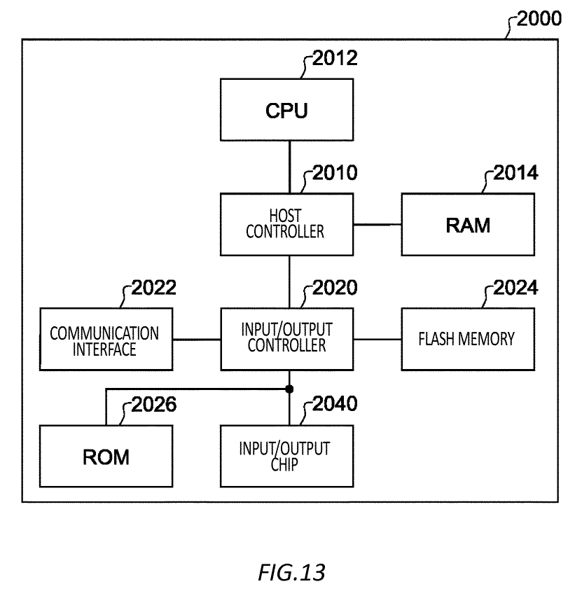

FIG. 13 illustrates an example of a computer 2000 in which a plurality of embodiments of the present invention may be entirely or partially embodied. A program installed in the computer 2000 can cause the computer 2000: to function as the system 5 or each unit of the system 5, or an apparatus such as the power control apparatus 40 and the vehicle management apparatus 60 or each unit of the apparatus according to the embodiment; to execute an operation associated with the system or each unit of the system, or the apparatus or each unit of the apparatus, and/or to execute a process or a step of the process according to the embodiment. Such a program may be executed by a CPU 2012 in order to cause the computer 2000 to execute a specific operation associated with some or all of the processing procedures and the blocks in the block diagrams described in the present specification.

The computer 2000 according to the present embodiment includes the CPU 2012 and a RAM 2014, which are mutually connected by a host controller 2010. The computer 2000 also includes a ROM 2026, a flash memory 2024, a communication interface 2022, and an input/output chip 2040. The ROM 2026, the flash memory 2024, the communication interface 2022, and the input/output chip 2040 are connected to the host controller 2010 via an input/output controller 2020.

The CPU 2012 operates in accordance with programs stored in the ROM 2026 and the RAM 2014, and thereby controls each unit.

The communication interface 2022 communicates with another electronic device via a network. The flash memory 2024 stores a program and data used by the CPU 2012 in the computer 2000. The ROM 2026 stores a boot program or the like executed by the computer 2000 upon activation, and/or a program that depends on hardware of the computer 2000. The input/output chip 2040 may also connect various input/output units such as a keyboard, a mouse, and a monitor, to the input/output controller 2020 via input/output ports such as a serial port, a parallel port, a keyboard port, a mouse port, a monitor port, a USB port, an HDMI (registered trademark) port.

A program is provided via a network or a computer-readable storage medium such as a CD-ROM, a DVD-ROM, or a memory card. The RAM 2014, the ROM 2026, or the flash memory 2024 is an example of a computer-readable storage medium. The program is installed in the flash memory 2024, the RAM 2014, or the ROM 2026, and executed by the CPU 2012. Information processing written in these programs is read by the computer 2000, and provides cooperation between the programs and the various types of hardware resources described above. An apparatus or a method may be constructed by realizing operations or processing of information in accordance with a use of the computer 2000.

For example, when a communication is executed between the computer 2000 and an external device, the CPU 2012 may execute a communication program loaded on the RAM 2014, and instruct the communication interface 2022 to execute communication processing based on processing described in the communication program. Under the control of the CPU 2012, the communication interface 2022 reads transmission data stored in a transmission buffer processing region provided in a recording medium such as the RAM 2014 or the flash memory 2024, transmits the read transmission data to the network, and writes reception data received from the network into a reception buffer processing region or the like provided on the recording medium.

In addition, the CPU 2012 may cause all or a necessary portion of a file or a database stored in a recording medium such as the flash memory 2024 and the like to be read into the RAM 2014, and execute various types of processing on the data in the RAM 2014. Next, the CPU 2012 writes back the processed data into the recording medium.

Various types of information, such as various types of programs, data, a table, and a database, may be stored in the recording medium and may be subjected to information processing. The CPU 2012 may execute, on the data read from the RAM 2014, various types of processing, including various types of operations, information processing, conditional judgement, conditional branching, unconditional branching, information search/replacement, or the like described in the present specification and designated by instruction sequences of the programs, and write back a result into the RAM 2014. In addition, the CPU 2012 may search for information in a file, a database, or the like in the recording medium. For example, when a plurality of entries each having an attribute value of a first attribute associated with an attribute value of a second attribute, is stored in the recording medium, the CPU 2012 may search for an entry having a designated attribute value of the first attribute that matches a condition from said plurality of entries, and read the attribute value of the second attribute stored in said entry, thereby obtaining the attribute value of the second attribute associated with the first attribute that satisfies a predefined condition.

The program or software module described above may be stored in a computer-readable storage medium on the computer 2000 or near the computer 2000. A recording medium, such as a hard disk or a RAM provided in a server system connected to a dedicated communication network or the Internet, can be used as the computer-readable storage medium. A program stored in the computer-readable storage medium may be provided to the computer 2000 via a network.

Programs that are installed in the computer 2000 and cause the computer 2000 to function as the integrated management apparatus 50 may cause, when executed by the computer, the computer 2000 to function as each unit of the integrated management apparatus 50 by working with the CPU 2012 or the like. The information processing described in these programs is read by the computer 2000, and the computer 2000 functions as each unit of the integrated management apparatus 50 which is a specific means in which software and the above-described various hardware resources cooperate. Then, when a computation or processing of information according to the intended use of the computer 2000 in the present embodiment is realized by these specific means, the unique integrated management apparatus 50 according to the intended use is constructed.

The program installed in the computer 2000 to cause the computer 2000 to function as the vehicle management apparatus 60 may work on the CPU 2012 or the like to cause the computer 2000 to function as each unit of the vehicle management apparatus 60. The information processing described in these programs is read by the computer 2000 to function as each unit of the vehicle management apparatus 60 which is a specific means in which software and the above-described various hardware resources cooperate. Then, when computation or processing of information according to the intended use of the computer 2000 in the present embodiment is realized by these specific means, the unique vehicle management apparatus 60 according to the intended use is constructed.

The program installed in the computer 2000 to cause the computer 2000 to function as the power control apparatus 40 may work on the CPU 2012 or the like to cause the computer 2000 to function as each unit of the power control apparatus 40. The information processing described in these programs is read by the computer 2000 to function as each unit of the power control apparatus 40 which is a specific means in which software and the above-described various hardware resources cooperate. Then, when computation or processing of information according to the intended use of the computer 2000 in the present embodiment is realized by these specific means, the unique power control apparatus 40 according to the intended use is constructed.

Various embodiments have been described with reference to the block diagrams and the like. In the block diagrams, each block may represent (1) a step of a process in which an operation is executed, or (2) each part of the device having a role in executing the operation. A particular step and each part may be implemented by a dedicated circuit, a programmable circuit supplied with computer-readable instructions stored on a computer-readable storage medium, and/or a processor supplied with computer-readable instructions stored on a computer-readable storage medium. The dedicated circuit may include a digital and/or analog hardware circuit, or may include an integrated circuit (IC) and/or a discrete circuit. The programmable circuit may include a reconfigurable hardware circuit including logical AND, logical OR, logical XOR, logical NAND, logical NOR, and another logical operation, and a memory element or the like, such as a flip-flop, a register, a field-programmable gate array (FPGA), a programmable logic array (PLA), or the like.

The computer-readable storage medium may include any tangible device capable of storing instructions to be executed by an appropriate device, so that the computer-readable storage medium having instructions stored therein constitutes at least a part of a product including instructions which can be executed to provide means for executing processing procedures or operations designated in the block diagrams. An example of the computer-readable storage medium may include an electronic storage medium, a magnetic storage medium, an optical storage medium, an electromagnetic storage medium, a semiconductor storage medium, etc. A more specific example of the computer-readable storage medium may include a FLOPPY (registered trademark) disk, a diskette, a hard disk, a random access memory (RAM), a read-only memory (ROM), an erasable programmable read-only memory (EPROM or flash memory), an electrically erasable programmable read-only memory (EEPROM), a static random access memory (SRAM), a compact disc read-only memory (CD-ROM), a digital versatile disk (DVD), a BLU-RAY (registered trademark) disk, a memory stick, an integrated circuit card, or the like.

The computer-readable instructions may include an assembler instruction, an instruction-set-architecture (ISA) instruction, a machine instruction, a machine-dependent instruction, a microcode, a firmware instruction, state-setting data, or either of source code or object code written in any combination of one or more programming languages including an object oriented programming language such as SMALLTALK (registered trademark), JAVA (registered trademark), and C++, or the like, and a conventional procedural programming language such as a "C" programming language or a similar programming language.

The computer-readable instruction is provided to the processor or programmable circuit of programmable data processing apparatuses, such as a computer locally or via a local area network (LAN), a wide area network (WAN) such as the Internet, and the computer-readable instruction may be executed in order to provide means to execute the operations specified in the described processing procedure or block diagrams.

Here, the computer may be a computer such as a personal computer (PC), a tablet computer, a smartphone, a workstation, a server computer, or a general-purpose computer, or may be a computer system in which a plurality of computers are connected. Such a computer system in which a plurality of computers are connected is also referred to as a distributed computing system, and is a computer in a broad sense. In a distributed computing system, a plurality of computers collectively execute a program by each of the plurality of computers executing a portion of the program, and passing data during the execution of the program among the computers as needed.

Examples of the processor include a computer processor, a central processing unit (CPU), a processing unit, a microprocessor, a digital signal processor, a controller, a microcontroller, and the like. The computer may include one processor or a plurality of processors. In a multi-processor system including a plurality of processors, the plurality of processors collectively execute a program by each of the processors executing a portion of the program, and passing data during the execution of the program among the processors as needed. For example, in execution of multitasking, each of the plurality of processors may execute a portion of each task piece by piece by performing task-switching for each time slice. In this case, which portion of one program each processor is responsible for executing dynamically changes. In addition, which portion of the program each of the plurality of processors is to execute may be statically defined by multiprocessor-aware programming.

While the present invention has been described by way of the embodiments, the technical scope of the present invention is not limited to the above-described embodiments. It is apparent to persons skilled in the art that various modifications or improvements can be made to the above-described embodiments. It is also apparent from the description of the claims that the embodiments to which such modifications or improvements are made may be included in the technical scope of the present invention.

Note that the operations, procedures, steps, and stages etc. of each process performed by a device, system, program, and method shown in the claims, specification, or diagrams can be executed in any order as long as the order is not indicated by "before", "prior to", or the like and as long as the output from a previous process is not used in a later process. Even if the operation flow is described using phrases such as "first" or "next" for the sake of convenience in the claims, specification, or drawings, it does not necessarily mean that the process must be performed in this order.

### EXPLANATION OF REFERENCES

5: system;

10: vehicle;

12: battery;

18: power generation apparatus:

20: user;

22: terminal;

30, 31: office;

40, 41: power control apparatus;

50, 51: integrated management apparatus;

60, 61: vehicle management apparatus;

70: power consumer;

80: power generation apparatus;

90: power network;

140: power control apparatus;

180: server;

190: communication network;

200: computation unit;

210: acquisition unit;

220: decision unit;

230: presentation control unit;

240: calculation unit;

242: determination unit;

250: accepting unit;

260: location-information acquisition unit

262: required duration acquisition unit;

270: reporting control unit;

280: storage unit;

290: communication unit;

300: computation unit;

310: acquisition unit;

340: decision unit;

380: storage unit;

390: communication unit;

500, 600, 700, 800, 900: screen;

503, 511, 513, 541, 613, 813, 913: input box;

504, 514, 515, 814, 815: display box;

510, 512, 540, 812: selection menu;

516, 518, 816: button;

713: warning object;

580: button;

1010, 1030, 1110: sign;

2000: computer;

2010: host controller;

2012: CPU;

2014: RAM;

2020: input/output controller;

2022: communication interface;

2024: flash memory;

2026: ROM;

2040 input/output chip.

What is claimed is:

1. An information processing apparatus which performs information processing for a travel schedule of a movable body, comprising:
a location-information acquisition unit which acquires location information that includes information indicating a scheduled departure location of the movable body, travel destination information indicating a first location scheduled as a travel destination of the movable body, and information indicating a scheduled return location of the movable body;
a required duration acquisition unit which acquires required duration information indicating a duration required for the movable body to travel, calculated based on the location information;
an accepting unit which performs processing for accepting information that has been input into a plurality of input items on a time at which, or a duration for which the movable body travels;
a determination unit which performs processing for determining that information has been input into a predefined number of at least one input item among the plurality of input items; and
a calculation unit which, when it is determined that the information has been input into the predefined number of at least one input item, performs processing for calculating information on at least one input item among the plurality of input items, into which no information has been input, based on the information that has been input into the predefined number of at least one input item having the information input thereinto, and the required duration information.

2. The information processing apparatus according to claim 1, wherein
the required duration information includes information indicating:
a first required duration which is required for the movable body to travel from the scheduled departure location to the first location; and
a second required duration which is required for the movable body to travel from the first location to the scheduled return location.

3. The information processing apparatus according to claim 2, wherein
the travel destination information further includes information indicating a second location scheduled as a travel destination of the movable body, and
the required duration information further includes information indicating a third required duration which is required to travel between the first location and the second location.

4. The information processing apparatus according to claim 1, wherein
the plurality of input items include an input item of a scheduled stay duration at the first location.

5. The information processing apparatus according to claim 4, wherein
the plurality of input items include a scheduled departure time at which the movable body departs from the scheduled departure location, the scheduled stay duration, and a scheduled return time at which the movable body returns to the scheduled return location.

6. The information processing apparatus according to claim 3, wherein
the plurality of input items include input items of a first scheduled stay duration at the first location and a second scheduled stay duration at the second location.

7. The information processing apparatus according to claim 6, wherein
the plurality of input items include a scheduled departure time at which the movable body departs from the scheduled departure location, the first scheduled stay duration, the second scheduled stay duration, and a scheduled return time at which the movable body returns to the scheduled return location.

8. The information processing apparatus according to claim 1, wherein
the predefined number is less than a number of the plurality of input items and is two or more.

9. The information processing apparatus according to claim 1, further comprising
a presentation control unit which performs control for causing a plurality of input fields for a user to perform input of information on the plurality of input items to be presented for each of the plurality of input items.

10. The information processing apparatus according to claim 9, wherein
the presentation control unit performs control for causing an input field which corresponds to an input item for which the calculation unit is to calculate the information, among the plurality of input fields, to present that the calculation unit is to calculate the information.

11. The information processing apparatus according to claim 9, wherein
the presentation control unit performs control for causing the plurality of input fields to be presented simultaneously.

12. The information processing apparatus according to claim 1, further comprising
a reporting control unit which performs control for performing reporting when the information calculated by the calculation unit satisfies a predefined condition.

13. The information processing apparatus according to claim 12, wherein
the predefined condition is set for each of the plurality of input items.

14. The information processing apparatus according to claim 1, further comprising
a computation unit which predicts, based on reservation information indicating usage reservation of the movable body, a transition of an amount of accumulated energy in an energy accumulation apparatus equipped in the movable body.

15. The information processing apparatus according to claim 14, wherein
the computation unit further performs, based on the information that has been input into the plurality of input items and the information calculated by the calculation unit, processing for energy exchange between the movable body and an outside of the movable body at the first location.

16. The information processing apparatus according to claim 2, wherein
the plurality of input items include an input item of a scheduled stay duration at the first location.

17. The information processing apparatus according to claim 3, wherein
the plurality of input items include an input item of a scheduled stay duration at the first location.

18. The information processing apparatus according to claim 16, wherein
the plurality of input items include a scheduled departure time at which the movable body departs from the scheduled departure location, the scheduled stay duration, and a scheduled return time at which the movable body returns to the scheduled return location.

19. An information processing method for a travel schedule of a movable body, comprising:
acquiring location information that includes information indicating a scheduled departure location of the movable body, travel destination information indicating a first location scheduled as a travel destination of the movable body, and information indicating a scheduled return location of the movable body;
acquiring required duration information indicating a duration required for the movable body to travel, calculated based on the location information;
performing processing for accepting information that has been input into a plurality of input items on a time at which, or a duration for which the movable body travels;
performing processing for determining that information has been input into a predefined number of at least one input item among the plurality of input items; and
when it is determined that the information has been input into the predefined number of at least one input item, performing processing for calculating information on at least one input item among the plurality of input items, into which no information has been input, based on the information that has been input into the predefined number of at least one input item having the information input thereinto, and the required duration information.

20. A computer-readable storage medium having recorded thereon a program for information processing for a travel schedule of a movable body, the program, when executed by a computer, causes the computer to function as:
a location-information acquisition unit which acquires location information that includes information indicating a scheduled departure location of the movable body, travel destination information indicating a first location scheduled as a travel destination of the movable body, and information indicating a scheduled return location of the movable body;
a required duration acquisition unit which acquires required duration information indicating a duration required for the movable body to travel, calculated based on the location information;
an accepting unit which performs processing for accepting information that has been input into a plurality of input items on a time at which, or a duration for which the movable body travels;
a determination unit which performs processing for determining that information has been input into a predefined number of at least one input item among the plurality of input items; and
a calculation unit which, when it is determined that the information has been input into the predefined number of at least one input item, performs processing for calculating information on at least one input item among the plurality of input items, into which no information has been input, based on the information that has been input into the predefined number of at least one input item having the information input thereinto, and the required duration information.
